(19) United States
(12) Patent Application Publication
(10) Pub. No.: US 2007/0243008 A1
(43) Pub. Date: Oct. 18, 2007

(54) Device and process for cleaning fiber optic connector contacts

(76) Inventor: John A. Vogt, Marlton, NJ (US)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/405,788

(22) Filed: Apr. 18, 2006

(51) Int. Cl. B43K 5/14; B43K 5/00

(52) U.S. Cl. 401/132; 401/205

(57) ABSTRACT

A fiber optic cleaning device having a hollow or tubular body containing a frangible ampoule cleaning fluid. Upon rupturing the ampoule, the cleaning fluid is released to a porous applicator couple to one end of the hollow body. The porous applicator is then applied to a fiber optic contact area for removing contaminants, such as dust.

This application claims benefit of Provisional U.S. Application Ser. No. 60,569,126, filed May 7, 2004, which is incorporated by reference as if fully set forth herein.

### FIELD OF INVENTION

The present invention relates to an electrical connection cleaning device. More particularly, the present invention relates to a fiber optic contact cleaning device and method. Most particularly, the present invention relates to a fiber optic cleaning device that is particularly useful for cleaning the interface between optic fibers used in data transmission.

### BACKGROUND

Fiber optic connectors of many types are used to connect fiber optic cables to optical fiber transmission devices or other fiber optic cables. A typical fiber optic connector includes separate female and male portions, each having one or more optical contacts housed in recesses of the respective portions. Each of the optical contacts securely receives a stripped end of a fiber optic cable such that at least one optic fiber end is rigidly positioned in each of the connector portions. Typically, the male and female connector portions are designed so that once joined the faces of the optical contacts are protected from environmental contamination.

Prior to making the connection, it is important to clean the faces of the optical contacts. Even the slightest contaminant, on or in the contact area, may affect the transmission of light between the mated contact surface. Currently, technicians often utilize a swab that has been dipped into a container of an alcohol solution to clean on and around the contacts. This process is inherently suspect and invites contamination of the swab and the alcohol solution. This process requires that a technician carry a container of alcohol solution and a package of swabs which may not remain sterile once the package is opened.

The art desires a device which simplifies and improves the cleaning of fiber optic contacts.

### SUMMARY

A fiber optic contact cleaning device and method are disclosed. The device comprises a hollow body having a frangible ampoule. The frangible ampoule is preferably flexed, such as by bending it, in order to rupture the ampoule. Once ruptured, a cleaning fluid is released and absorbed by a porous applicator coupled to one end of the hollow body. The porous applicator is then applied to a fiber optic surface or contact for removing contaminants such as dust.

### BRIEF DESCRIPTION OF THE DRAWINGS

FIG. 1 is a side elevation of a contact cleaning device according to a preferred embodiment of the present invention.

FIG. 2 is a front elevation of the device taken along the line 2-2 in FIG. 1.

FIG. 3 is a side elevation of the device of FIG. 1 with a cover in place.

FIG. 4 illustrates a typical connector portion to be cleaned with the contact cleaning device.

FIG. 5 is a side elevation of an alternative embodiment of the present invention.

FIG. 6 is a side elevation of another alternative embodiment of the present invention.

FIG. 7 is a perspective view of the porous applicator shown in FIG. 6.

FIG. 8 is a side elevation of another alternative embodiment of the present invention.

FIG. 9 is a side elevation of a contact cleaning device according to a preferred embodiment of the present invention which incorporates a funnel tip.

FIG. 10 is a side elevation of a funnel tip having an exterior depression for joining it to a body according to another embodiment of the present invention.

FIG. 11 is a side elevation of a slotted funnel tip.

FIG. 12 is a perspective view of an embodiment of the invention having a proximal funnel tip with the distal end closed by flattening of the body.

FIG. 13 illustrates the front and back views of the invention of FIG. 12.

FIG. 14 illustrates the distal view of the embodiment of FIG. 12.

FIG. 15 illustrates the proximal view of the embodiment of FIG. 12.

FIG. 16 illustrates the left and right side views of FIG. 12.

FIG. 17 is a perspective view of an embodiment of the invention having a funnel tip at the proximal end with the distal end of the body closed by a cap.

FIG. 18 illustrates the front, back and side views for the invention illustrated in FIG. 17.

FIG. 19 illustrates the distal view of the embodiment of FIG. 17.

FIG. 20 illustrates the proximal view of the embodiment of FIG. 17.

### DETAILED DESCRIPTION OF THE PREFERRED EMBODIMENT(S)

The preferred embodiments of the present invention will be described with reference to the drawing figures wherein like numerals represent like elements throughout.

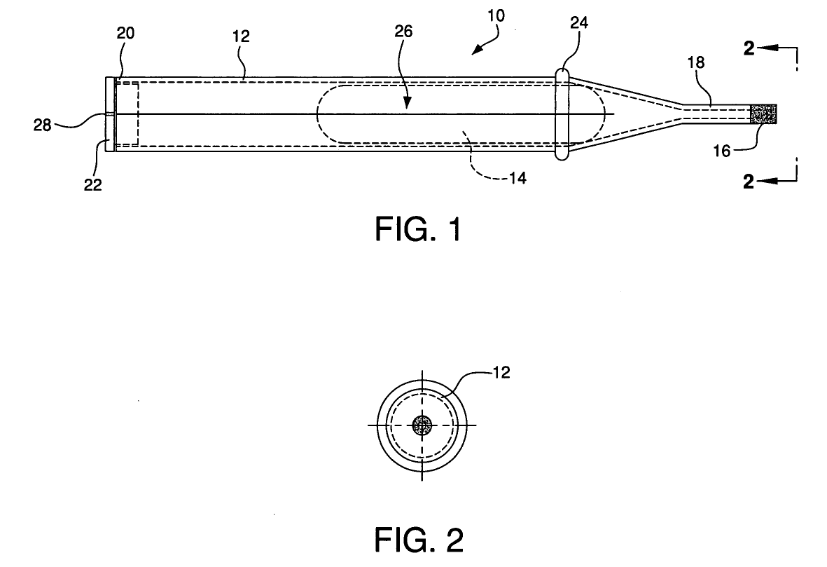

FIG. 1 shows a contact cleaning device 10 according to a preferred embodiment of the present invention. The cleaning device 10 includes a hollow bendable body 12, closed at one end and opened at the other, that houses a sealed ampoule 14 filled with a cleaning fluid. A porous applicator 16 is joined to the open ended tip 18 of the bendable body 12.

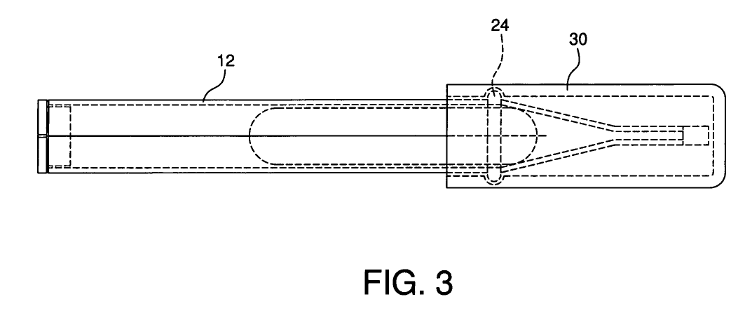

The bendable body 12 is generally stable or rigid lengthwise, but has sufficient flexibility or elasticity in the crosswise direction to allow a breaking or bending pressure to fracture the ampoule 14 without the body 12 being cracked or broken. The body 12 is preferably formed of a suitably flexible plastic material, such as ABS, PVC, or Acrylic; however, other bendable materials like rubber may also be used. The grip 24 provides for easy manipulation of the cleaning device 10, and is further useful for helping to retain a protective cover 30, as shown in FIG. 3. Preferably, the cap 30 fits tightly and protects the applicator from contamination.

The ampoule 14 is a breakable sealed container, preferably formed of glass or plastic, which holds a measured amount of cleaning fluid. The plastic or glass material is preferably of a type which breaks cleanly without producing small shards or particles. Preferably, the cleaning fluid is an alcohol solution, although, the ampoule 14 may contain other suitable residue free cleaning fluids which evaporate quickly. During assembly of the device 10, the ampoule 14 is inserted in open or distal end 20 of the hollow body 12, and a cap 22, preferable with a vent hole, closes the end 20. If desired, an adhesive such as epoxy, acrylic or silicone, may be utilized to prevent shifting of the ampoule 14 within the body 12. Care must be taken to select an adhesive which will not react with or contaminate the cleaning fluid. Alternatively, the body 12 may be heat staked to position the ampoule 14 in place.

The porous applicator 16, preferably adhered to or formed in place on the tip or proximal end 18, is an open cell material that will not react with or contaminate the cleaning fluid. The adhesive used in attaching the porous applicator 16 must not contaminate or react with the cleaning fluid. One suitable material is polypropylene in particular a medical grade such as approved by the FDA.

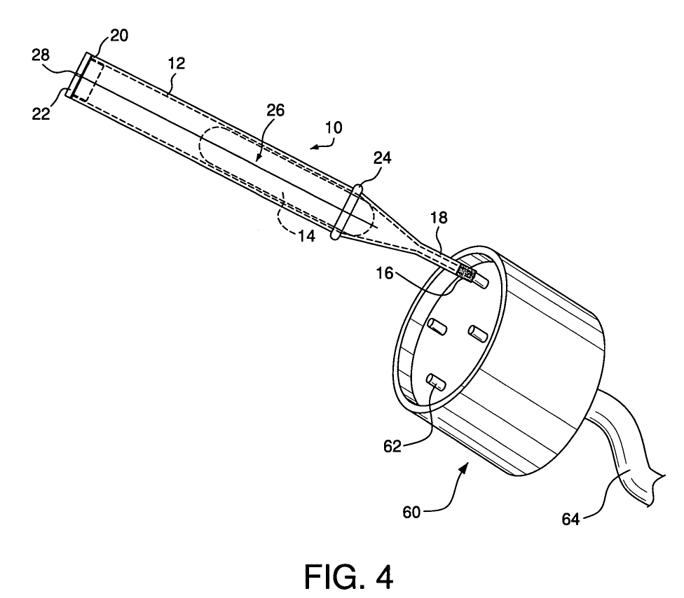

Referring to FIG. 4, there is illustrated a fiber optic connector portion 60 which requires cleaning prior to being connected with a mating connector portion (not shown). The connector portion 60 includes fiber optic contacts 62 for mating with corresponding contacts on a mating connector portion. Each fiber optic contact 62 houses one or more optical fibers from a jacketed cable 64. To allow a good connection with minimal transmission losses between optical fibers, all contact faces must be substantially free from contaminants including dust, dirt, debris and oils. Before use, the contact cleaning device 10, with the porous applicator 16 is protected from contamination by the cover 30, as shown in FIG. 3. When a connector portion such as 64 requires cleaning, the hollow bendable body 12 is bent to rupture the ampoule 14. Preferably, the body 12 indicates, such as the indicator mark 26, where the body 12 should be manipulated to most easily rupture the ampoule 14. Cleaning fluid released from the ampoule 14 travels to the tip 18 of the body 12 where it is absorbed by the porous applicator 16. Preferably, a vent hole 28 permits venting air to enter inside the body 12 to help cleaning fluid to flow out of the tip 18 into the porous applicator 16. After cleaning fluid is absorbed by the applicator 16, the cleaning device 10 is manipulated to gently brush the surface of the fiber optic contacts 62. After the contacts are cleaned, the area surrounding the contacts on the connector portion may also be wiped to prevent contamination. Cleaning the connector portions in this manner reduces contamination and prevents transmission losses between mating surfaces or contacts.

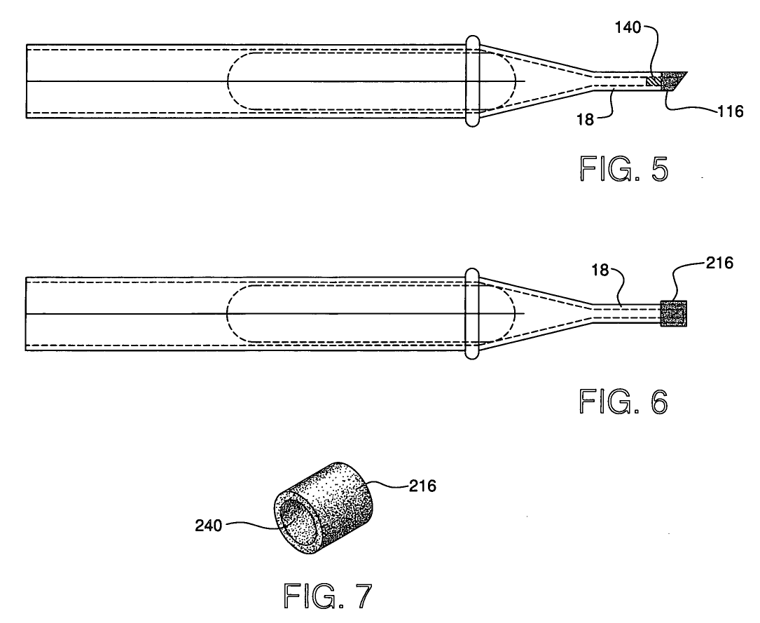

FIG. 5 shows an alternative porous applicator 116. The applicator 116 is secured to and in the tip 18 by an interference fit plug 140, formed integrally with the applicator 116.

FIGS. 6 and 7 show another alternative porous applicator 216 which includes an aperture 240 for receiving the tip 18 therein. The aperture 240 is slightly smaller than the outer diameter of the tip 18 to provide an interference fit for securely attaching the porous applicator 216 about and to the tip 18. Like the prior embodiment, this is a form of friction fitting the applicator. Depending on the material selected, friction fitting may also be used to spin weld the applicator to the body.

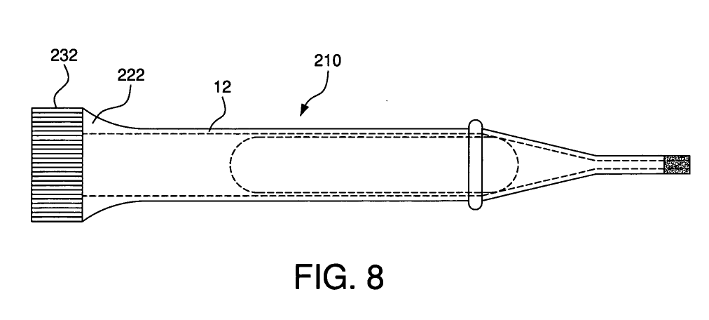

Referring to FIG. 8, an alternative embodiment of the present invention is shown. A contact cleaning device 210 includes a housing 12 identical to the housing 12 used in the above described contact cleaning device 10. In this embodiment, a grip cap 222, having a ridged grip 232, is used in place of the vent cap 22 to facilitate assembly of the device 210. The end grip 232 is useful when the cleaning device 210 must be gripped at the end in order to reach into a recess.

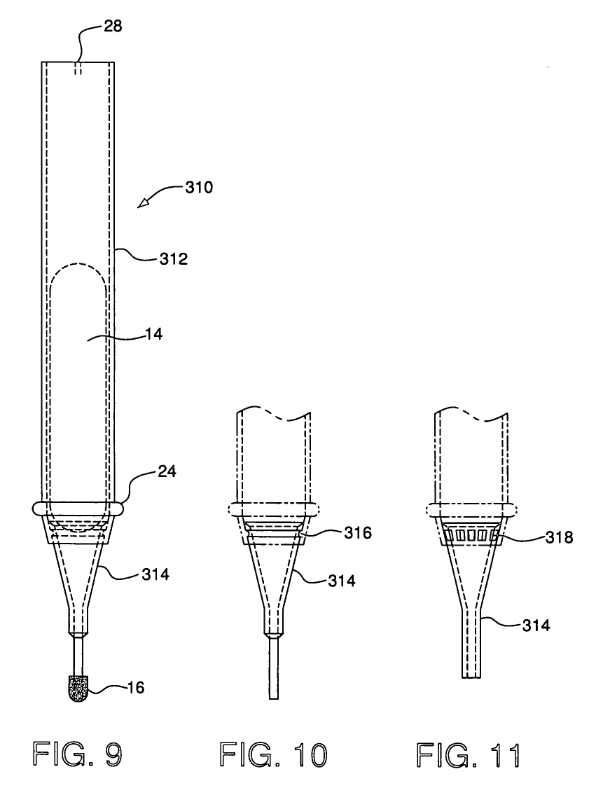

In all respects to the embodiments and features above, FIG. 9 shows contact cleaning device 310 according to another preferred embodiment of the present invention. The cleaning device 310 includes a tubular, bendable body 312 closed at one end and open at the other end, similar to an elongated test tube. The funnel 314 has a first narrow end and a wider circular second end. The circular second end of the metallic funnel is slightly smaller than the open end of the bendable body 312 and is over molded by the end of the body 312. This allows the circular second end of the metallic funnel to fit tightly to the bendable body 312. By being coupled to the body 312 at the open end, the metallic funnel 314 extends beyond the body 312 to provide reduced size tip for application within the connector, but is still sealed to the body.

FIG. 10 shows one embodiment of the metallic funnel 314 having a depression or recess. The bendable body 312 and metallic funnel 314 are again over molded together to form a locking portion at the depression or recess to secure the metallic funnel 314 to the bendable body 312 and ensure that the coupling is liquid tight.

FIG. 11 shows another embodiment of the metallic funnel having a one or more spaced apart slots. The bendable body 312 and metallic funnel 314 are again molded together.

Still with reference to FIGS. 9-11, the bendable body 312 houses a sealed ampoule 14 filled with cleaning fluid. A porous applicator 16 is coupled to the narrow end of the metallic funnel. The bendable body 312 is generally stable in length, but allows the necessary amount of elastic or plastic bending to fracture the ampoule 14 without being cracked or broken. The body 312 is preferably formed of a suitable plastic material such as ABS, PVC, or Acrylic; however, other bendable materials like rubber may also be used. The metallic funnel is preferably comprised of aluminum, steel, copper, zinc, or tin; however, other metallic metals may also be used. A grip 24 provides for easy manipulation of the cleaning device 310, and is further useful for helping to retain a protective cover 30(not shown), similar to that shown in FIG. 3. Preferably, the cap 30 fits tightly over the metallic funnel and protects the applicator from contamination. The body 312 may also have an indicator to identify the flexible portion or position to bend.

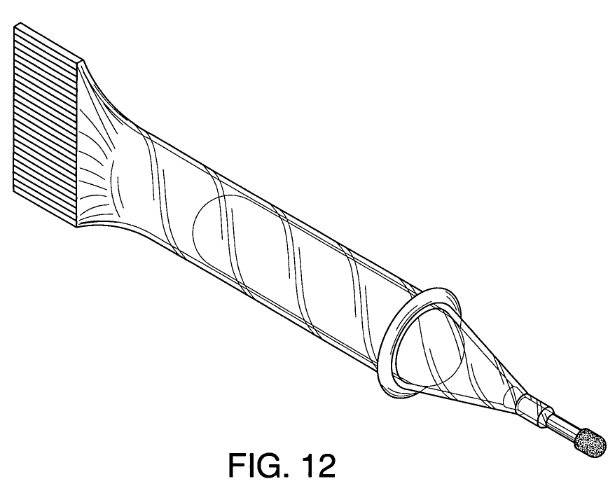

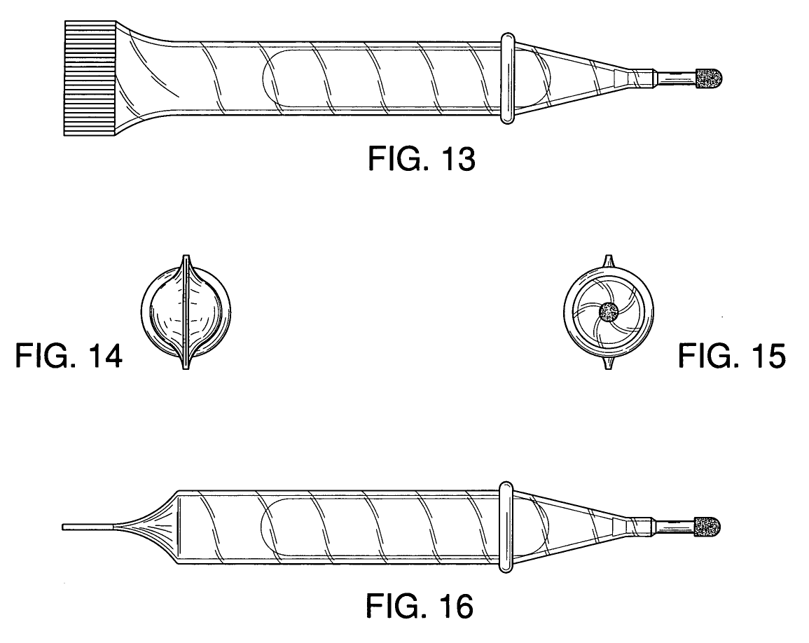

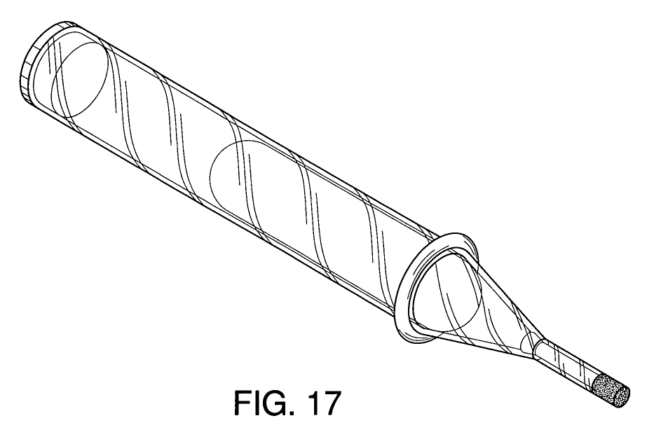

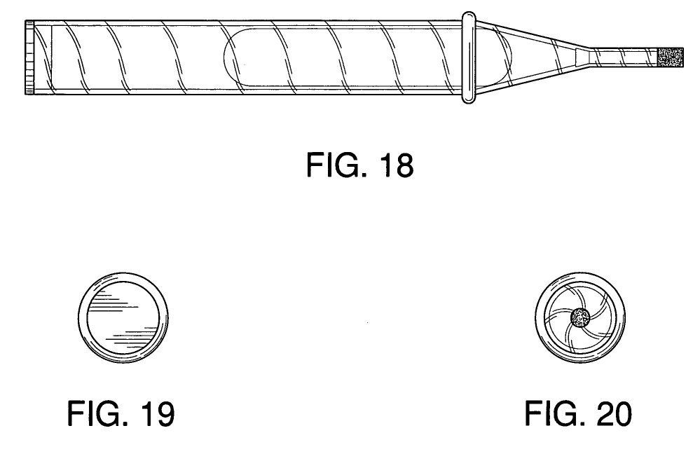

With reference to FIGS. 12 through 16, there is shown an embodiment where the distal end is closed by flatting, in the manner of a toothpaste tube, and, preferably heat sealed at the same time of the flatting operation which is preferably carried out under sufficient to soften the body. With reference to FIGS. 17 through 20, there is shown an embodiment where the distal end is closed by a cap, plug or other insert which is preferably sealed in place by an adhesive or spin welding.

With reference to FIGS. 17-20, there is illustrates a funnel tip embodiment where the body 312 is over molded for the entire length of the funnel tip.

While preferred embodiments of the invention have been described in detail, the invention is not limited to these specific embodiments described above which should be considered as merely exemplary. Further modifications and extensions of the present invention may be developed and all such modifications are deemed to be within the scope of the present invention as defined by the appended claims.

What is claimed is:

1. A contact cleaning device comprising:
a hollow body having a flexible portion and at least one open end;
a frangible ampoule of a cleaning fluid positioned within the hollow body in proximity to the flexible portion of the body and in fluid communication with the open end; and
a fluid absorbing, porous applicator coupled to the open end and in fluid communication with the frangible ampoule.

2. The device of claim 1 wherein the flexible portion of the hollow body is bendable.

3. The device of claim 1 wherein manipulation of the flexible portion of the hollow body ruptures the frangible ampoule and releases the cleaning fluid.

4. The device of claim 1 wherein the cleaning fluid is an evaporating fluid.

5. The device of claim 1 wherein both ends of the hollow body are open ends.

6. The device of claim 5 wherein one open end of the hollow body is closed by a cap.

7. The device of claim 6 wherein the cap includes a vent hole.

8. The device of claim 1 wherein the flexible portion is identified with an indicator.

9. The device of claim 1 wherein the hollow body is of a material selected from the group comprised of ABS, PVC, Acrylic and rubber.

10. The device of claim 1 wherein the frangible ampoule is forms of a material which ruptures into discrete particles.

11. The device of claim 1 wherein the frangible ampoule contains a predetermined amount of cleaning fluid.

12. The device of claim 1 wherein the cleaning fluid is residue free.

13. The device of claim 1 wherein the cleaning fluid is an alcohol.

14. The device of claim 1 further comprising a grip attached to the hollow body.

15. The device of claim 14 wherein the grip surrounds the hollow body.

16. The device of claim 14 wherein the grip is located proximate to the open end.

17. The device of claim 14 wherein the grip secures a protective cover to the hollow body.

18. The device of claim 1 further comprising a protective cover over the porous applicator.

19. The device of claim 1 wherein the frangible ampoule is fixed in position within the hollow body.

20. The device of claim 1 wherein the frangible ampoule is fixed in position within the hollow body by heat staking.

21. The device of claim 1 wherein the frangible ampoule is fixed in position within the hollow body by an adhesive.

22. The device of claim 21 wherein the adhesive is selected from the group comprised of epoxy, acrylic and silicone based adhesives.

23. The device of claim 1 wherein the porous applicator material is selected to prevent contamination of the cleaning fluid.

24. The device of claim 23 wherein the porous applicator is coupled to the open end of the body by a friction fit.

25. The device of claim 23 wherein a ridged grip is coupled to the closed end of the hollow body.

26. The device of claim 1 wherein the porous applicator has a portion thereof that is secured to the open end by an interference fit.

27. A contact cleaning device comprising:
a hollow body having a flexible portion, a closed end and at least one open end;
a frangible ampoule of a cleaning fluid positioned within the hollow body in between the ends and in fluid communication with the open end;
a fluid applicator coupled to the open end and in fluid communication with the frangible ampoule; and
a removable cap that covers the applicator.

28. The device of claim 27 wherein the removable cap is engaged with an external ring on the hollow body.

29. The device of claim 28 wherein the closed end of the body is closed by a cap.

30. The device of claim 27 wherein the hollow body is of a material selected from the group comprised of ABS, PVC, Acrylic and rubber.

31. A method for cleaning a fiber optic contact area, the method comprising the steps of:
providing a hollow body having a closed end, a flexible portion, a frangible ampoule of cleaning fluid located within the flexible portion and an open end which is closed by an applicator in fluid contact with the hollow body;
applying pressure to the flexible portion to break the frangible ampoule; and
applying the porous applicator to a fiber optic contact area.

32. A contact cleaning device comprising:
a tubular body having distal and proximal ends;
a tip coupled to the proximal end of the tubular body;
a frangible ampoule of a cleaning fluid positioned within the tubular body in proximity to the proximal end and in fluid communication with the tip; and
a fluid absorbing, porous applicator coupled to the tip.

33. The device of claim 32 wherein the tip is metallic.

34. The device of claim 32 wherein the tip includes a funnel portion that defines a tubular body joining location.

35. The device of claim 32 wherein the cleaning fluid is an evaporating fluid.

36. The device of claim 32 wherein the flexible portion is identified with an indicator.

37. The device of claim 32 wherein the tubular body is closed at the distal end by a flattened portion.

38. The device of claim 37 wherein the flattened portion of the tubular body is heat sealed.

39. The device of claim 32 wherein the tubular body is closed at the distal end by insert.

40. The device of claim 39 wherein an adhesive secures the insert in place.

41. The device of claim 32 wherein spin welding secures the insert in place.
